(19) United States
(12) Patent Application Publication
(10) Pub. No.: US 2024/0014482 A1
(43) Pub. Date: Jan. 11, 2024

(54) BATTERY

(71) Applicant: Prime Planet Energy & Solutions, Inc., Tokyo (JP)

(72) Inventor: Katsuji TSUJIOKA, Nishinomiya-shi (JP)

(21) Appl. No.: 18/346,860

(22) Filed: Jul. 5, 2023

(30) Foreign Application Priority Data
Jul. 11, 2022 (JP) 2022-111145

(51) Int. Cl. H01M 50/172; H01M 50/186; H01M 50/184

(52) U.S. Cl. CPC H01M 50/172; H01M 50/186; H01M 50/184

(57) ABSTRACT

In one preferable aspect of a battery herein disclosed, the sealing plate includes: an electrode terminal electrically joined at one end thereof with any electrode of positive and negative electrodes inside a battery case, the electrode terminal inserted at the other end thereof through the terminal mounting hole to be exposed to outside the sealing plate, and an insulating member for establishing an insulation between an outer surface of a surface of the sealing plate, the outer surface being outside the battery case with an opening sealed, and the collector terminal, and the insulating member includes an exposed part exposed to the outer side surface. Herein, comparison between a fitting part and the second collar part indicates that a height of the fitting part from a bottom wall of the battery case is higher than a height of the second collar part from the bottom wall of the battery case.

### CROSS REFERENCE TO RELATED APPLICATIONS

The present application claims priority based on Japanese Patent Application No. 2022-111145 filed on Jul. 11, 2022, the entire contents of which are incorporated by reference in the present specification.

### BACKGROUND

The present disclosure relates to a battery.

In recent years, a battery such as a lithium ion secondary battery has been preferably used for a portable power supply of a personal computer, a portable terminal, or the like, a power supply for driving a car such as an electric vehicle (BEV), a hybrid vehicle (HEV), or a plug-in hybrid vehicle (PHEV). Such a battery has, for example, an opening, and is manufactured by joining a battery case for accommodating an electrode body and a sealing plate for sealing the opening by laser irradiation or the like. For example, Japanese Patent Application Publication No. 2021-86813, Japanese Patent Application Publication No. H07-183011, and Japanese Patent Application Publication No. 2008-251474 disclose such batteries.

### SUMMARY

Incidentally, a study by the present inventors has indicated as follows: with the insulating member having an exposed part exposed above the case member as with, for example, Japanese Patent Application Publication No. 2021-86813, the thermal effect caused by laser reflection or the like at the time of joining as described above can cause burn at the exposed part. Such burn of the insulating member is preferably suppressed from the viewpoint of the reliability of a battery or the like.

The present disclosure was completed in view of such circumstances. It is the main object of the present disclosure to provide a battery preferably improved in reliability.

In order to implement such an object, the present disclosure provides a battery including: an electrode body including respective electrodes of positive and negative electrodes; a battery case including an opening, and for accommodating the electrode body; a sealing plate including a terminal mounting hole, and for sealing the opening; and a fitting part for fitting the opening and the sealing plate thereon. The sealing plate has: an electrode terminal electrically joined at one end thereof with any electrode of the positive and negative electrodes inside the battery case, and is inserted at the other end thereof through the terminal mounting hole to be exposed to outside the sealing plate; and an insulating member for establishing an insulation between an outer surface of a surface of the sealing plate, and being outside the battery case with the opening sealed, and the electrode terminal. The insulating member has an exposed part exposed to the outer surface, where comparison between the fitting part and the exposed part indicates that a height of the fitting part from a bottom wall of the battery case is equal to or larger than a height of the exposed part from the bottom wall of the battery case.

Thus, when the height of the fitting part from the bottom wall of the battery case is equal to or larger than the height of the exposed part from the bottom wall of the battery case, the exposed part becomes less likely to be affected by the thermal effect as described above. As a result, it is possible to preferably suppress the burn of the insulating member.

### BRIEF DESCRIPTION OF THE DRAWINGS

FIG. 1 is a perspective view schematically showing a battery in accordance with one embodiment;

FIG. 2 is an exploded view schematically showing the battery in accordance with one embodiment;

FIG. 3 is a schematic top view of a sealing plate of FIG. 1;

FIG. 4 is a schematic longitudinal cross sectional view along line IV-IV of FIG. 1;

FIG. 5 is a schematic view of a molding die in accordance with one embodiment; and

FIG. 6 is a view corresponding to FIG. 4 in accordance with another embodiment.

### DETAILED DESCRIPTION

Below, with reference to the accompanying drawings, some preferable embodiments of the technology disclosed herein will be described. Incidentally, matters necessary for executing the present disclosure, except for matters specifically referred to in the present specification (e.g., the general configuration and manufacturing process of a battery not characterizing the present disclosure) can be grasped as design matters of those skilled in the art based on the related art in the present field. The present disclosure can be executed based on the contents disclosed in the present specification and the technical common sense in the present field. Further, the embodiment herein described is naturally not intended to limit particularly the present disclosure.

Further, each drawing is a schematic drawing, and does not necessarily reflect an actual working product. Below, the members and portions producing the same action will be given the same reference numerals and signs, and an overlapping description thereon will be appropriately omitted or simplified. Herein, in the drawings, the front, the rear, the up, the down, the left, and the right are expressed as F, Rr, U, D, L, and R, respectively. However, the front, the rear, the up, the down, the left, and the right are only the directions for convenience of description, and do not limit the setting aspect of the battery, and the like. Then, the following description is not intended to limit the technology herein disclosed to the following embodiments.

Incidentally, in the present specification, the term “battery” is a term denoting an electric storage device capable of extracting an electric energy in general, and is a concept including a primary battery and a secondary battery. Further, in the present specification, the term “secondary battery” is a term denoting an electric storage device capable of repeatedly charging and discharging in general, and is a concept including a so-called storage battery (chemical battery) such as a lithium ion secondary battery or a nickel hydrogen battery, and a capacitor (physical battery) such as an electric double layer capacitor. Further, the electrolyte included in the battery may be any of a liquid electrolyte (electrolyte), a gel electrolyte, and a solid electrolyte.

Configuration of Battery

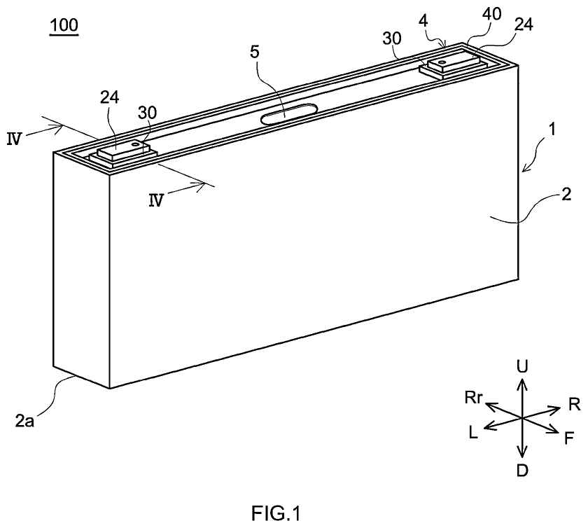

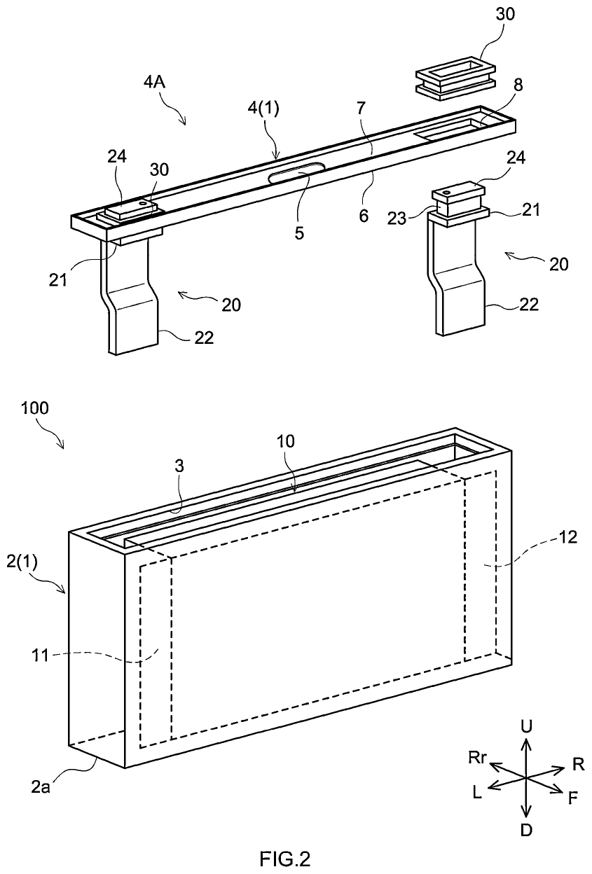

FIG. 1 is a perspective view schematically showing a battery 100. FIG. 2 is an exploded view schematically showing the battery 100. As shown in FIG. 2, the battery 100 includes a battery case 1, an electrode body 10, a collector terminal 20, and an insulating member 30. In FIG. 2, an assembly component (which will be hereinafter referred to as a sealing plate assembly 4A) including a collector terminal 20 and an insulating member 30 integrally molded with a sealing plate 4 of one component of the battery case 1, and other components are shown separately. Further, in FIG. 2, for the negative electrode, the sealing plate 4, the collector terminal 20, and the insulating member 30 are shown separately.

The battery case 1 includes a case main body 2 and a sealing plate 4. The case main body 2 and the sealing plate 4 are examples of the case members forming the battery case 1. The case main body 2 accommodates an electrode body 10 and an electrolyte. The case main body 2 is a flat rectangular container in a shape of a substantially rectangular parallelepiped. The case main body 2 is opened at one side surface between a pair of side surfaces forming the opposing broad surfaces. As the case main body 2, for example, the one made of a metal such as aluminum or an aluminum alloy can be preferably used.

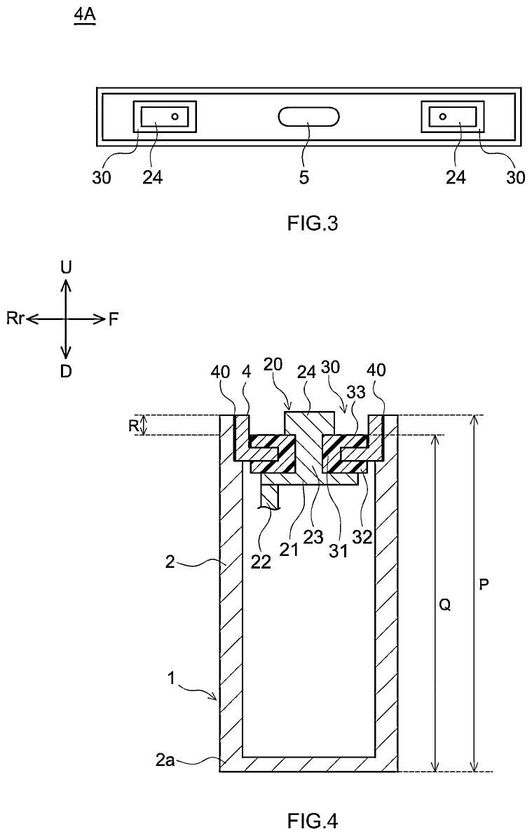

The sealing plate 4 is a member for sealing an opening 3 of the case main body 2. As shown in FIG. 2 and FIG. 3, the sealing plate 4 is a tray-shaped member dented in the thickness direction thereof (the direction D of FIG. 2). In this case, it is configured such that the height of the outer surface (outer side surface 7) from the bottom wall 2a of the battery case 1 is lower than the height of the fitting part 40 from the bottom wall 2a of the battery case 1. Such a sealing plate 4 facilitates the positioning at the time of fitting between the case main body 2 and the sealing plate 4, and hence is preferable. The sealing plate 4 can be manufactured by, for example, using a die. Although the separated state is shown in FIG. 2, with the finished product of the battery 100 (see FIG. 1), the sealing plate 4 and the opening 3 of the case main body 2 are fitted by a fitting part 40, such that the sealing plate 4 is joined with the periphery of the opening 3 of the case main body 2. As the sealing plate 4, for example, the one made of a metal such as aluminum or an aluminum alloy can be preferably used. The sealing plate 4 also has an inner side surface 6 facing the inside of the battery 100, and an outer side surface 7 facing the outside thereof. The sealing plate 4 has a terminal mounting hole 8 penetrating through the inner side surface 6 and the outer side surface 7. The terminal mounting holes 8 are provided one on the positive electrode side of the sealing plate 4 and one on the negative electrode side thereof. The terminal mounting hole 8 establishes a communication between the inside and the outside of the battery case 1.

The sealing plate 4 is provided with a thin-walled safety valve 5 set so as to relax the internal pressure when the internal pressure of the battery case 1 increases to a prescribed level, or higher. Further, the battery case 1 is provided with an introduction hole (not shown) for introducing an electrolyte.

The electrode body 10 is accommodated in the case main body 2. The electrode body 10 is accommodated in the case main body 2, for example, while being covered with an insulation film (not shown), or the like. The electrode body 10 includes a positive electrode sheet 11, a negative electrode sheet 12, and a separator sheet (not shown) arranged between the positive electrode sheet 11 and the negative electrode sheet 12. The positive electrode sheet 11, the negative electrode sheet 12, and the separator sheet are long band-shaped members, respectively. The positive electrode sheet 11, the negative electrode sheet 12, and the separator sheet are stacked one on another, and are wound in the case main body 2. Incidentally, the technology herein disclosed is also applicable to, for example, the case where the electrode body is a lamination type electrode body in which a positive electrode sheet and a negative electrode sheet are stacked one on another via a separator sheet.

The positive electrode sheet 11 is a member in which a positive electrode active material layer including a positive electrode active material is formed on each opposite surface of metal foil (e.g., aluminum foil) with preset width and thickness. Incidentally, in other embodiments, the positive electrode active material layer may be formed on only one surface of the positive electrode sheet. The positive electrode active material is, for example, a material capable of releasing lithium ions during charging and absorbing lithium ions during discharging as with a lithium transition metal composite material for a lithium ion secondary battery. Various positive electrode active materials have been generally proposed other than the lithium transition metal composite material, and have no particular restriction.

The negative electrode sheet 12 is a member in which a negative electrode active material layer including a negative electrode active material is formed on each opposite surfaces of metal foil (e.g., copper foil) with preset width and thickness. Incidentally, in other embodiments, the negative electrode active material layer may be formed on only one surface of the negative electrode sheet. The negative electrode active material is, for example, a material capable of occluding lithium ions during charging and releasing the lithium ions occluded during charging, during discharging as with natural graphite for a lithium ion secondary battery. Various negative electrode active materials have been generally proposed other than natural graphite, and have no particular restriction.

For the separator sheet, for example, a porous resin sheet having a desired heat resistance, and through which an electrolyte can pass is used. Various separator sheets have also been proposed, and have no particular restriction.

As the electrolyte, a conventionally known one for use in this kind of battery can be used. For example, the one containing a support salt in an organic solvent (nonaqueous solvent) can be used.

The positive electrode sheet 11 wound in the case main body 2 is arranged such that one end thereof is in the vicinity of the left end in the case main body 2. The negative electrode sheet 12 is arranged such that one end thereof is in the vicinity of the right end in the case main body 2. Although FIG. 2 shows them in a separated state, the collector terminals 20 are welded one with the positive electrode sheet 11 and one with the negative electrode sheet 12 for a finished product of the battery 100.

The sealing plate assembly 4A is an assembly component including the sealing plate 4, the collector terminal 20, and the insulating member 30 assembled therein by integral molding (insert molding). Such a configuration enables easy removal of the sealing plate assembly 4A, and hence is preferable from the viewpoint of workability. A part of the collector terminal 20 is arranged in the inside of the battery case 1, and the other part is arranged in the outside of the battery case 1. Further, although not shown as described above, the collector terminal 20 is connected with the electrode body 10 in the inside of the battery case 1. Incidentally, the collector terminal 20 on the negative electrode side is formed of, for example, copper or a copper alloy. The collector terminal 20 on the positive electrode side is formed of, for example, aluminum or an aluminum alloy.

FIG. 4 is a cross sectional view of the vicinity of a terminal mounting hole 8 of the sealing plate 4. FIG. 4 is a IV-IV cross sectional view of FIG. 1. As shown in FIG. 4, the collector terminal 20 includes a base part 21, an electrode body connection part 22, a shaft part 23, and an outer connection part 24. Incidentally, below, the configuration of the vicinity of the terminal mounting hole 8 for extracting the electrode of the electrode body 10 to the outside of the battery case 1 will also be referred to as an “electrode extraction part”.

The base part 21 is configured in a shape of a tetragonal planar sheet, and extends in the horizontal direction. As shown in FIG. 4, the longitudinal length of the base part 21 is longer than that of the terminal mounting hole 8. Although not shown, as for the lateral direction, the length of the base part 21 is longer than that of the terminal mounting hole 8. The base part 21 has a larger radial size than that of the terminal mounting hole 8.

The electrode body connection part 22 is arranged in the inside of the battery case 1, and is connected with the electrode body 10. As shown in FIG. 2, the electrode body connection part 22 is formed in a shape of a sheet, and extends from the rear end of the base part 21 downward. The electrode body connection part 22 is bent at the intermediate part toward the forward side. The electrode body connection part 22 extends downward again below the bent portion. The bending allows the tip of the electrode body connection part 22 to be situated at the central part of the base part 21 for the longitudinal direction.

The shaft part 23 is arranged between the electrode body connection part 22 and the outer connection part 24 arranged in the outside of the battery case 1, and is inserted through the terminal mounting hole 8. The shaft part 23 extends from the base part 21 upward. As shown in FIG. 4, the longitudinal direction of the shaft part 23 is shorter than those of the base part 21 and the terminal mounting hole 8. Although not shown, also for the lateral direction, the length of the shaft part 23 is shorter than those of the base part 21 and the terminal mounting hole 8. For this reason, the shaft part 23 is separated from the inner circumferential surface of the terminal mounting hole 8.

The outer connection part 24 is provided above the shaft part 23. The outer connection part 24 is exposed to the outer side surface 7 of the sealing plate 4. As shown in FIG. 4, the longitudinal length of the outer connection part 24 is shorter than those of the base part 21 and the terminal mounting hole 8, and is longer than that of the shaft part 23. Although not shown, also for the lateral direction, the length of the outer connection part 24 is shorter than those of the base part 21 and the terminal mounting hole 8, and is longer than that of the shaft part 23. The outer connection part 24 is configured with a size capable of being inserted through the terminal mounting hole 8. The shaft part 23 is formed in such a shape as to be constricted with respect to the base part 21 and the outer connection part 24 due to the difference in size among the base part 21, the shaft part 23, and the outer connection part 24.

The insulating member 30 establishes an insulation between the outer surface (outer side surface 7) of the surface of the sealing plate 4, and being outside the battery case 1 with the opening 3 sealed and the collector terminal 20. The insulating member 30 is integrally molded with the sealing plate 4 and the collector terminal 20 so as to fill the space between the terminal mounting hole 8 and the collector terminal 20. More particularly, the insulating member 30 is formed in the inside of the terminal mounting hole 8, on the further inner side of the battery case 1 than the inner side surface 6 of the sealing plate 4, and on the further outer side of the battery case 1 than the outer side surface 7 of the sealing plate 4. The insulating member 30 has a tubular part 31 situated between the terminal mounting hole 8 and the shaft part 23 of the collector terminal 20, a first collar part 32 extending in the horizontal direction along the inner side surface 6 of the sealing plate 4, and a second collar part 33 extending in the horizontal direction along the outer side surface 7 of the sealing plate 4. The tubular part 31, the first collar part 32, and the second collar part 33 are integrally formed. As shown in FIG. 4, each longitudinal length of the first collar part 32 and the second collar part 33 is longer than that of the base part 21 and the outer connection part 24 of the collector terminal 20. Although not shown, also for the lateral direction, each length of the first collar part 32 and the second collar part 33 is longer than that of the base part 21 and the outer connection part 24 of the collector terminal 20.

As shown in FIG. 1 and FIG. 4, the insulating member 30 includes an exposed part (herein, a second collar part 33) exposed to the outer surface (outer side surface 7) of the sealing plate 4. Then, the height P of the fitting part 40 from the bottom wall 2a of the battery case 1 is higher than the height Q of the second collar part 33 from the bottom wall 2a of the battery case 1 (see FIG. 4). With such a configuration, when the opening 3 of the case main body 2 and the sealing plate 4 are joined with each other at the fitting part 40, the second collar part 33 becomes less likely to be affected by the thermal effect of laser reflection or the like. As a result of this, it is possible to preferably suppress the burn of the insulating member 30. For this reason, a battery 100 preferably improved in reliability can be obtained.

The range of the ratio (R/P) of the height R of from the second collar part 33 (the outermost surface of the second collar part 33) to the fitting part 40 (see FIG. 4) to the height P of from the bottom wall of the case main body 2 to the fitting part 40 has no particular restriction so long as the effects of the technology herein disclosed can be obtained. On the other hand, for example, from the viewpoint of preferably suppressing the burn of the insulating member 30 (particularly, the second collar part 33), the lower limit of the ratio (R/P) is, for example, 1/20 or more, preferably 1/10 or more, and may be 1/5 or more. Further, for example, from the viewpoint of preferably ensuring the capacity of the battery, the upper limit of the ratio (R/P) is, for example, 1/3 or less, and preferably 1/4 or less.

The insulating member 30 is formed, for example, of a PFA resin. However, the insulating member 30 may only be a material having moldability, insulation property, sealability, and a resistance to the electrolyte, and is not limited to a PFA resin. Examples of other preferable materials for the insulating member 30 may include a PPS resin. Incidentally, in consideration of the difference between the temperature at the time of molding of the insulating member 30 and the temperature at the time of use of the battery 100, the coefficient of linear expansion of the sealing plate 4 and the coefficient of linear expansion of the insulating member 30 are preferably closer to each other. Thus, preferably, to the insulating member 30, other than a PFA resin, or the like, a filler for adjusting the coefficient of linear expansion may be added.

Manufacturing Method of Battery

Subsequently, one example of the method for manufacturing a battery 100 will be described. The method for manufacturing a battery 100 is characterized by implementing the configuration in which the height of the fitting part 40 from the bottom wall 2a of the battery case 1 is equal to or larger than the height of the second collar part 33 from the bottom wall 2a of the battery case 1. Other manufacturing processes may be the same as those in the related art. Further, the manufacturing method herein disclosed may include still other steps at a given stage.

First, a method for manufacturing a sealing plate assembly 4A will be described. The sealing plate assembly 4A in accordance with the present embodiment is manufactured by integral molding of the sealing plate 4, the collector terminal 20, and the insulating member 30. The integral molding process (the manufacturing process of the sealing plate assembly 4A after preparation of the sealing plate 4, the collector terminal 20, and the insulating member 30) includes a component setting step, a positioning step, an upper die setting step, an injection molding step, an upper die releasing step, and a component extracting step.

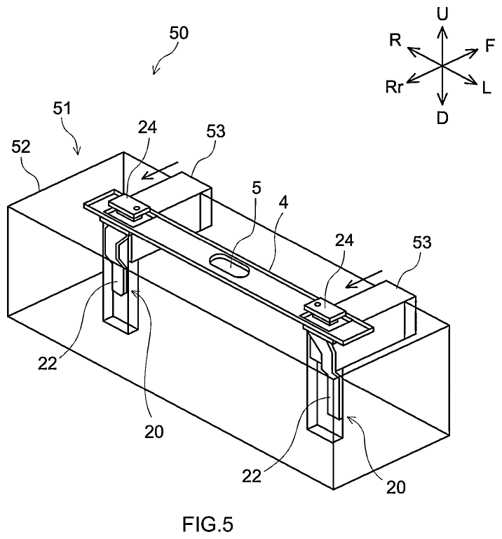

In the component setting step, the sealing plate 4 is mounted on a molding die. FIG. 5 is a schematic view of a molding die 50. However, FIG. 5 shows only a lower die 51 of the molding die 50, and the upper die is not shown. In FIG. 5, the directions used for indicating the directions of the battery 100 in FIG. 1, or the like are used as they are. However, this is not intended to limit the setting aspect of the molding die 50, and the like.

As shown in FIG. 5, the lower die 51 includes a main body 52, and two slide members 53. The main body 52 supports and positions the sealing plate 4. Further, the main body 52 includes a concave part (not shown) into which a molten resin flows. In the component setting step, after inserting the collector terminal 20 into the terminal mounting hole 8 of the sealing plate 4, the sealing plate 4 is mounted at the main body 52 of the lower die 51. The outer connection part 24 of the collector terminal 20 is configured with a size capable of being inserted into the terminal mounting hole 8. Thus, the collector terminal 20 is inserted into the terminal mounting hole 8 from the outer connection part 24 side.

After mounting the sealing plate 4 and the positive and negative collector terminals 20 on the main body 72 of the lower die 51, for example, a prescribed operation such as switch pressing down is performed, such that the positioning step is started. At the positioning step, the two slide members 53 retracted to the forward side move backward. As a result of this, the collector terminal 20 is sandwiched between the main body 52 and the slide member 53. The collector terminal 20 is supported and positioned thereby. The rear surface of the slide member 53 has a shape corresponding to the bent shape of the electrode body connection part 22 of the collector terminal 20. Incidentally, when the electrode body connection part 22 of the collector terminal 20 extends in the vertical direction without bending, a slide member is not particularly necessary, and a lower die not including a movable part is available. The shape of the collector terminal 20 has no particular restriction, and for example, as described above, the electrode body connection part 22 may be flat. Upon completion of the positioning step, the concave part of the lower die 51 is situated between the terminal mounting hole 8 of the sealing plate 4 and the base part 21 of the collector terminal 20.

At the upper die setting step, an upper die not shown descends from above together with the lower die 51 so as to sandwich the sealing plate 4 and the collector terminal 20 in the vertical direction. The upper die includes a sealing part to come in contact with the lower die 51, a concave part into which a resin flows, and a gate part connected with the concave part. The gate part is the inlet for a molten resin to the molding die 50. The gate part is connected with the resin ejection port of an injection molding machine. The concave part of the upper die faces the concave part of the lower die 51 across the sealing plate 4.

At the injection molding step, first, the molding die 50 is heated. Although the heating temperature varies according to the kind of the resin, it is about 100° C. to 200° C. Upon completion of heating of the molding die 50, a molten resin is injected from the gate part. The molten resin is filled in the concave part of the upper die, and further passes through the terminal mounting hole 8 to be filled in the concave part of the lower die 51. Subsequently, the molding die 50 and the molded product are cooled. As a result of this, the insulating member 30, the sealing plate 4, and the collector terminal 20 are integrally molded.

At the upper die releasing step, the upper die ascends, and is separated from the lower die 51. At the component extracting step, the molded product is removed from the lower die 51. Incidentally, after the component extracting step, there may be a step of removing the gate part of the resin and the molding burr.

As described up to this point, the sealing plate assembly 4A is prepared, and the electrode connection part 32 of the sealing plate assembly 4A and the electrode body 10 are connected with each other. Then, the electrode body 10 is inserted through the opening 3 of the case main body 2, and the peripheries of the sealing plate 4 and the opening 3 of the case main body 2 are joined by laser welding or the like. Subsequently, an electrolyte is injected from the injection hole, and the solution injection hole is blocked by a sealing member, thereby hermetically sealing the battery 100. In the manner described up to this point, the battery 100 can be manufactured.

The battery 100 is usable for various applications, and can be preferably used as, for example, a power source (a driving power supply) for a motor to be mounted on a vehicle such as a car or a truck. The kind of the vehicle has no particular restriction, and examples thereof may include a plug-in hybrid vehicle (PHEV; Plug-in Hybrid Electric Vehicle), a hybrid vehicle (HEV; Hybrid Electric Vehicle), and an electric vehicle (BEV; Battery Electric Vehicle).

Up to this point, some embodiments of the present disclosure have been described, and the embodiments are merely examples. The present disclosure can be executed additionally in various aspects. The present disclosure can be executed based on the contents disclosed in the present specification, and the technical common sense in the present field. The technology described in the appended claims includes various modifications and changes of the embodiments exemplified above. For example, a part of the embodiment can be replaced with another modified aspect, and another modified aspect can also be added to the embodiment. Further, the technical features can also be appropriately erased unless they are described as essential ones.

For example, in the embodiment, on the positive electrode side and on the negative electrode side, the exposed parts (herein, the second collar parts 33) are both present below the fitting part 40 (in the direction D of FIG. 1). However, the present disclosure is not limited thereto. Only any one of the positive electrode side and the negative electrode side can be formed in such a configuration. Further, for example, in the embodiment, the sealing plate assembly 13 is manufactured by integral molding (insert molding). However, the present disclosure is not limited thereto. The technology herein disclosed is also applicable to the sealing plate assembly manufactured by other methods than integral molding. Furthermore, the shape of the battery case may be other shapes such as a cylindrical shape so long as the effects of the technology herein disclosed are exerted.

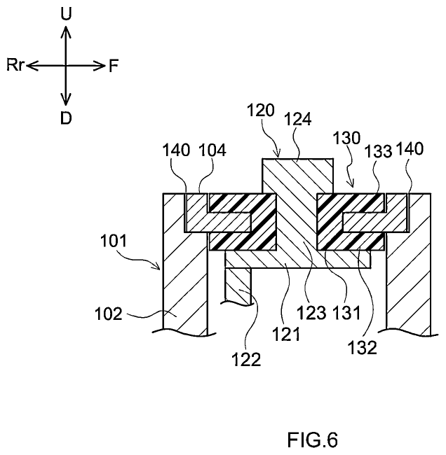

For example, in the embodiment, it is configured such that the height of the fitting part 40 from the bottom wall 2a of the battery case 1 is higher than the height of the second collar part 33 from the bottom wall 2a of the battery case 1. However, the present disclosure is not limited thereto. As shown in FIG. 6, it can also configured such that the height of the fitting part 140 from the bottom wall of the battery case 101 is equal to the height of the exposed part (herein, the second collar part 133) from the bottom wall of the battery case 101 (i.e., such a configuration that the second collar part 133 is present to be flush with the fitting part 140). Incidentally, it is assumed that 102, 104, 120, 121, 122, 123, 124, 130, 131, and 132 in FIG. 6 correspond to 2, 4, 20, 21, 22, 23, 24, 30, 31, and 32 in FIG. 4, respectively.

For example, in the embodiment, as the sealing plate 4, a tray-shaped member dented in the thickness direction thereof (the direction D of FIG. 2) is used. However, the present disclosure is not limited thereto. For example, the sealing plate 4 may be in a shape of a plate without a dent. Alternatively, for example, it can be also configured as follows: in the sealing plate 4, only the vicinity of the insulating member 30 is set as a concave part, and other portions are set in a shape of convex relative to the concave part. More particularly, there can be used a sealing plate configured such that the vicinity of the insulating member 30 on the positive electrode side-the central part including the safety valve 5-the vicinity of the insulating member 30 on the negative electrode side is formed in a shape of concave-convex-concave. Such a sealing plate 4 can be manufactured by using, for example, a die.

1. A battery comprising:
an electrode body including respective electrodes of positive and negative electrodes;
a battery case including an opening, and for accommodating the electrode body;
a sealing plate including a terminal mounting hole, and for sealing the opening; and
a fitting part for fitting the opening and the sealing plate thereon, wherein
the sealing plate includes:
an electrode terminal electrically joined at one end thereof with any electrode of the positive and negative electrodes inside the battery case, the electrode terminal inserted at the other end thereof through the terminal mounting hole to be exposed to outside the sealing plate; and
an insulating member for establishing an insulation between an outer surface of a surface of the sealing plate, the outer surface being outside the battery case with the opening sealed, and the electrode terminal, wherein
the insulating member includes an exposed part exposed to the outer surface, wherein comparison between the fitting part and the exposed part indicates that a height of the fitting part from a bottom wall of the battery case is equal to or higher than a height of the exposed part from the bottom wall of the battery case.

2. The battery according to claim 1, wherein the sealing plate is bent in a thickness direction of the sealing plate.

3. The battery according to claim 1, wherein the electrode terminal and the insulating member are integrally molded.
